(19) United States
(12) Patent Application Publication
(10) Pub. No.: US 2011/0263141 A1
(43) Pub. Date: Oct. 27, 2011

(54) VERTICAL RECEPTACLE CONNECTOR AND VERTICAL RECEPTACLE CONNECTOR ASSEMBLY

(75) Inventor: Wen-Chih Ko, Hsin-Tien City (TW)

(73) Assignee: ADVANCED CONNECTEK INC., Hsin-Tien City (TW)

(21) Appl. No.: 12/827,044

(22) Filed: Jun. 30, 2010

(30) Foreign Application Priority Data
Apr. 21, 2010 (TW) 099207260

(51) Int. Cl. H01R 12/16; H01R 13/648

(52) U.S. Cl. 439/83; 439/607.01

(57) ABSTRACT

A vertical receptacle connector is mounted vertically on a PCB to form a vertical receptacle connector assembly and has an insulating housing, multiple first terminals, multiple second terminals and a shell. The insulating housing has a front end and a rear end. The first and second terminals are mounted on the insulating housing and each of the first and second terminals has a soldering section horizontally extending backward out of the rear end of the insulating housing. The shell covers the insulating housing and first and second terminals and has a cavity defined through the shell and having a socket hole. The vertical configuration of the vertical receptacle connector on the PCB may be applied to specific electronic devices.

### BACKGROUND OF THE INVENTION

1. Field of the Invention

The present invention relates to a connector, and more particularly to a vertical receptacle connector that complies with the Universal Serial Bus (USB) 3.0 standard and may be mounted vertically on a printed circuit board (PCB) so that an axis of a socket hole of the vertical receptacle connector is vertical to the PCB. Such vertical connector configuration is applied to specific electronic devices.

2. Description of Related Art

Conventional Universal Serial Bus (USB) 2.0 connectors are used popularly in various electronic devices. Most of computer peripherals are equipped with USB connectors. Because electronic devices are constantly developed to increase transmission speed thereof, the USB 2.0 protocol does not meet the current transmission speed requirement of new electronic devices. Therefore, the USB Implementers Forum sets forth new USB 3.0 protocol for higher data transmission speed.

However, a conventional USB 3.0 receptacle connector is mounted on a PCB horizontally with an axis of a socket hole of the receptacle connector paralleling the PCB. To mount such receptacle connector horizontally on the PCB, soldering sections of terminals on the receptacle connector are bent to L-shape so that the soldering sections are mounted vertically through mounting holes of the PCB. Such configuration of the receptacle connector and PCB is applied to many electronic devices. However, some special electronic devices require that receptacle connectors are vertically mounted on PCBs. The conventional USB 3.0 receptacle connector cannot be applied to such specific electronic devices.

To overcome the shortcomings, the present invention provides a vertical receptacle connector to mitigate or obviate the aforementioned problems.

### SUMMARY OF THE INVENTION

The main objective of the invention is to provide a vertical receptacle connector that complies with the Universal Serial Bus (USB) 3.0 standard and may be mounted vertically on a printed circuit board (PCB) so that an axis of a socket hole of the vertical receptacle connector is vertical to the PCB. Such vertical connector configuration is applied to specific electronic devices.

A vertical receptacle connector in accordance with the present invention is mounted vertically on a PCB to form a vertical receptacle connector assembly and comprises an insulating housing, multiple first terminals, multiple second terminals and a shell. The insulating housing has a front end and a rear end. The first and second terminals are mounted on the insulating housing and each of the first and second terminals has a soldering section horizontally extending backward out of the rear end of the insulating housing. The shell covers the insulating housing and first and second terminals and has a cavity defined through the shell and having a socket hole. The vertical configuration of the vertical receptacle connector on the PCB may be applied to specific electronic devices.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a vertical receptacle connector in accordance with the present invention mounted on a PCB;

FIG. 2 is an exploded perspective view of the vertical receptacle connector and the PCB in FIG. 1;

FIG. 3 is a rear perspective view of the vertical receptacle connector in FIG. 1;

FIG. 4 is a front perspective view of the vertical receptacle connector in FIG. 3 without the shell; and

FIG. 5 is a rear perspective view of the vertical receptacle connector in FIG. 4;

FIG. 6 is an exploded front perspective view of the vertical receptacle connector in FIG. 3;

FIG. 7 is an exploded rear perspective view of the vertical receptacle connector in FIG. 3;

FIG. 8 is a cross sectional side view of the vertical receptacle connector in FIG. 1; and

FIG. 9 is another cross sectional side view of the vertical receptacle connector in FIG. 1.

### DETAILED DESCRIPTION OF THE PREFERRED EMBODIMENT

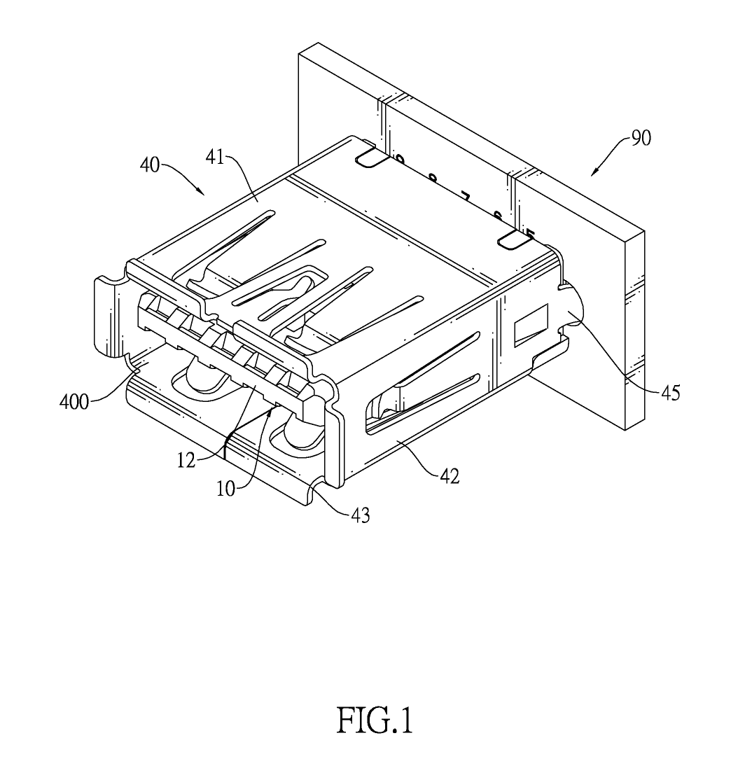

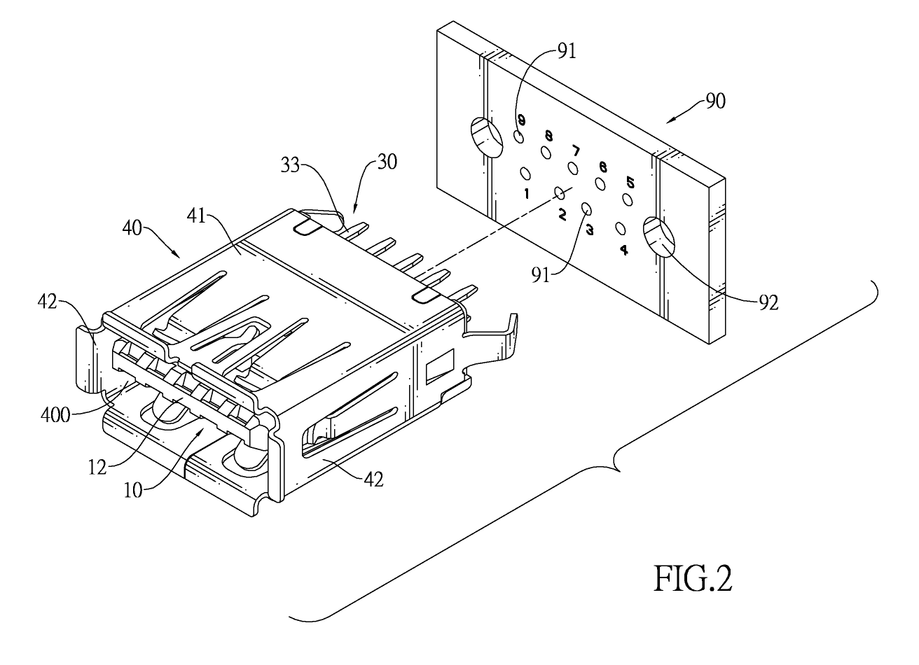

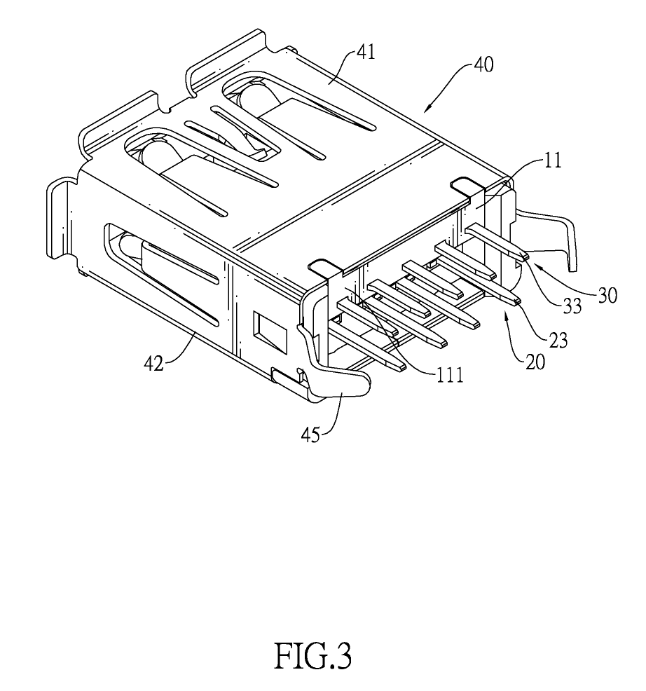

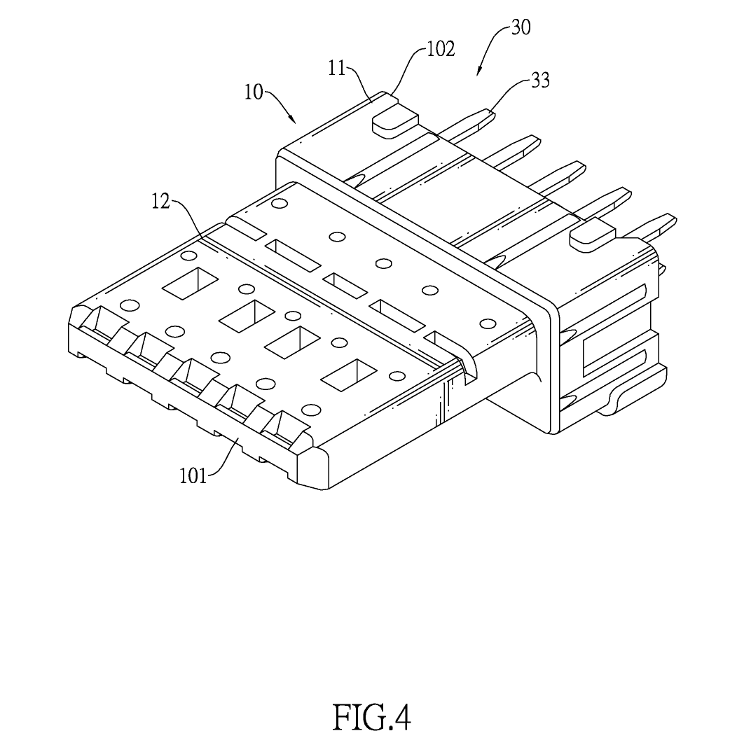

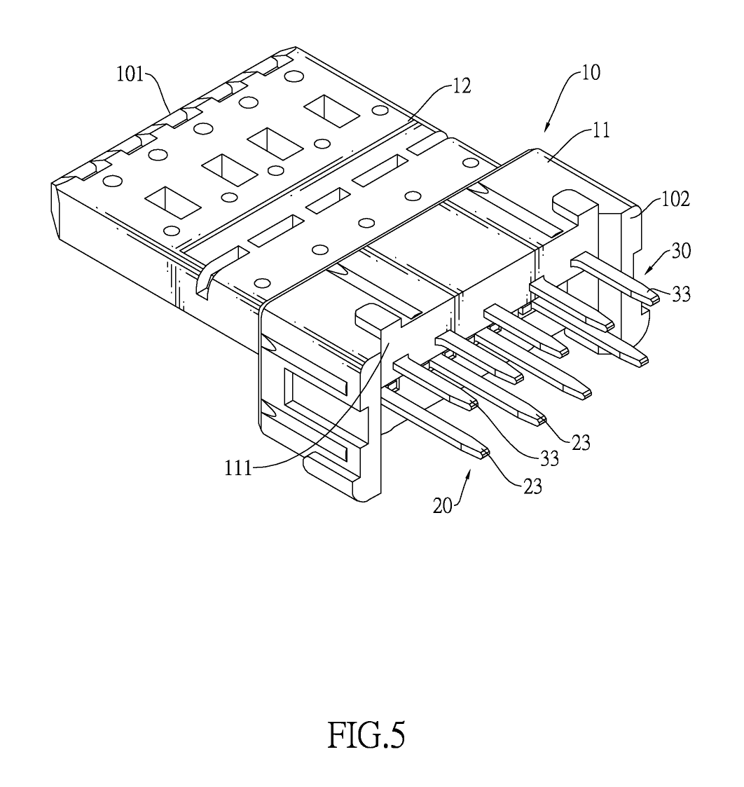

With reference to FIGS. 1 to 5, a vertical receptacle connector in accordance with the present invention is mounted vertically on a PCB (90) to form a vertical receptacle connector assembly. The PCB (90) has multiple soldering holes (91) and two positioning holes (92) defined through the PCB (90).

The vertical receptacle connector comprises an insulating housing (10), multiple first terminals (20), multiple second terminals (30) and a shell (40).

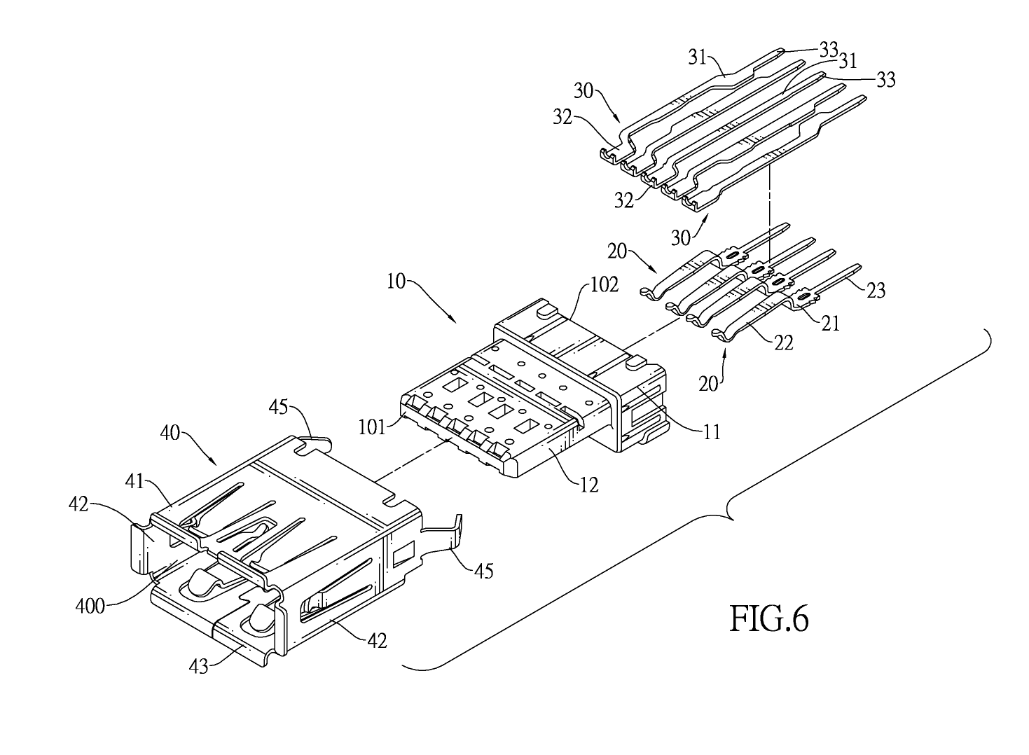

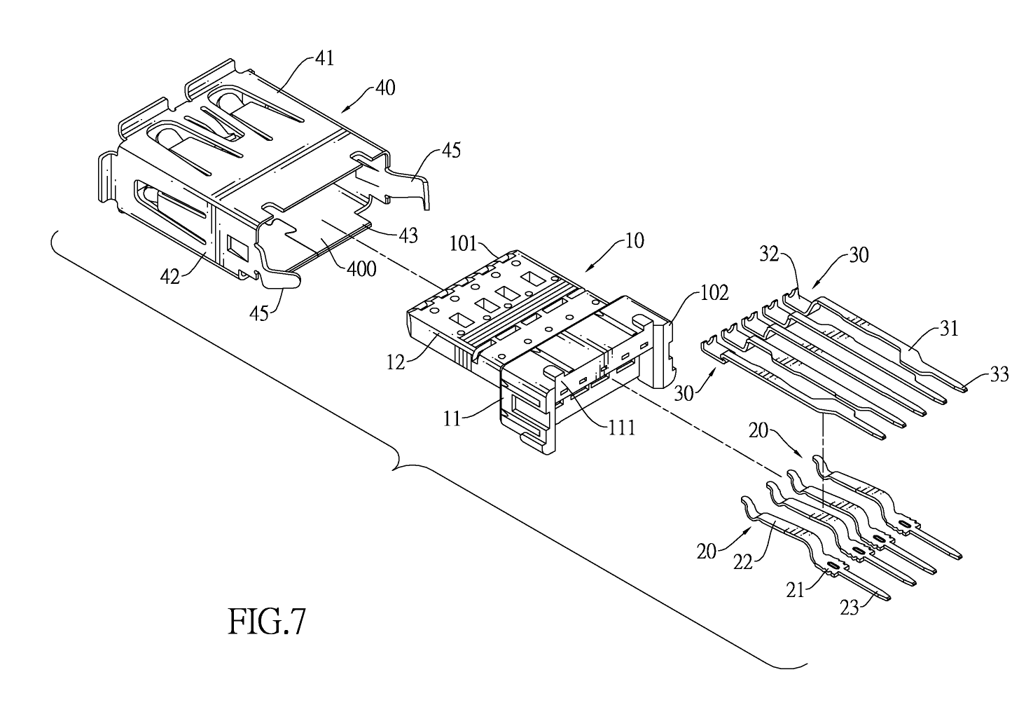

With further reference to FIGS. 6 and 7, the insulating housing (10) has a front end (101) and a rear end (102) and may have a base (11) and a tongue (12).

The base (11) is defined adjacent to the rear end (102) and has a front and a rear (111).

The tongue (12) is formed on and protrudes horizontally forward from the front of the base (11), is defined adjacent to the front end (101) and has a bottom.

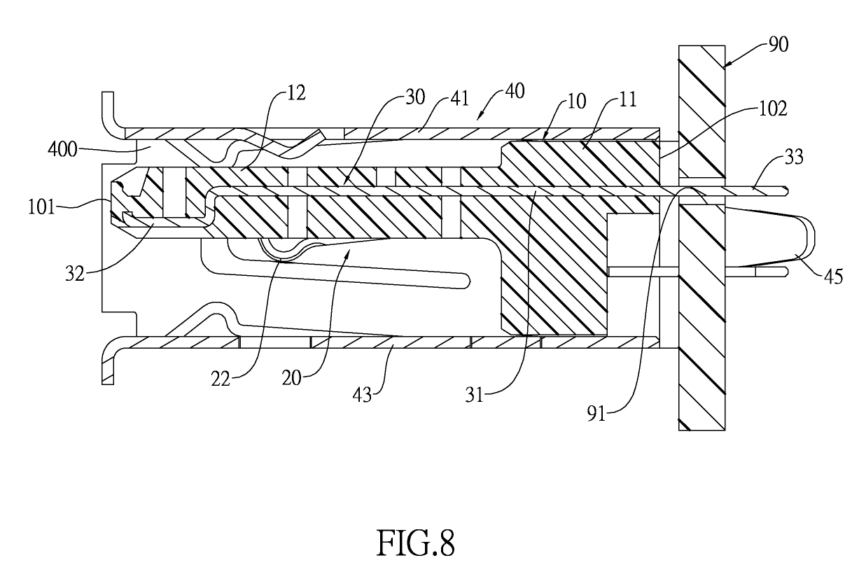

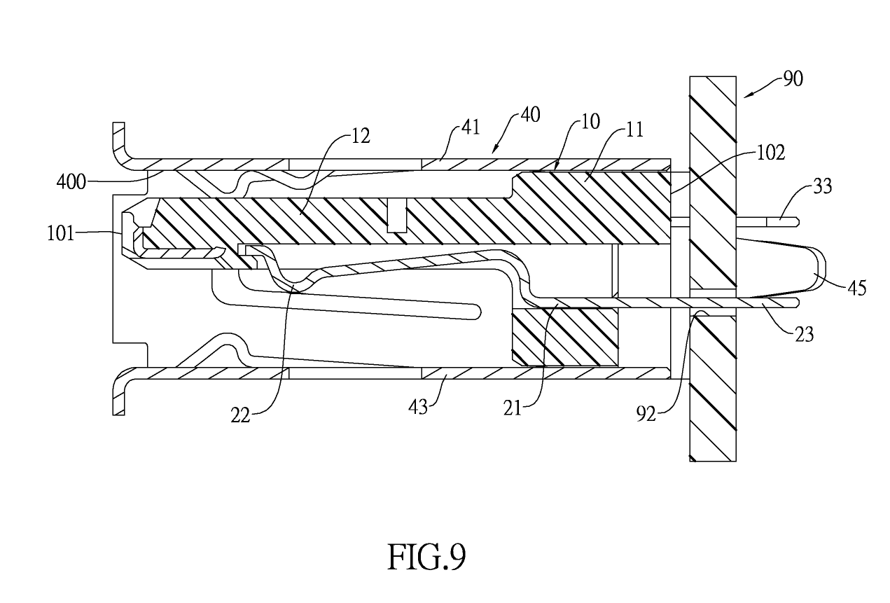

With reference to FIGS. 8 and 9, the first terminals (20) are mounted on the insulating housing (10), are capable of implementing USB 2.0 protocol and each first terminal (20) has a first mounting section (21), a first contacting section (22) and a first soldering section (23).

The first mounting section (21) is mounted in the base (11) and the tongue (12).

The first contacting section (22) is formed on and protrudes forward from the first mounting section (21) and is mounted on the bottom of the tongue (12).

The first soldering section (23) is formed on and protrudes horizontally backward from the first mounting section (21), extends horizontally out of the rear end (102) of the insulating housing (10), may extend horizontally backward out of the rear (111) of the base (11) and is mounted through one of the soldering holes (91) of the PCB (90). The definition of the aforementioned term “horizontally” is substantially distributing or extending along a direction from the front end (101) to the rear end (102) or from the rear end (102) to the front end (101) of the insulating housing (10). Such definition is also applied throughout the following descriptions.

The second terminals (30) are mounted on the insulating housing (10), are capable of cooperating with the first terminals (20) to implement USB 3.0 protocol and each second terminal (30) has a second mounting section (31), a second contacting section (32) and a second soldering section (33).

The second mounting section (31) is mounted in the base (11).

The second contacting section (32) is formed on and protrudes forward from the second mounting section (31) and is mounted on the bottom of the tongue (12).

The second soldering section (33) is formed on and protrudes horizontally backward from the second mounting section (31), extends horizontally out of the rear end (102) of the insulating housing (10), may extend horizontally backward out of the rear (111) of the base (11) and is mounted through one of the soldering holes (91) of the PCB (90).

The shell (40) covers the insulating housing (10), the first terminals (20) and the second terminals (30) and has a cavity (400), a top plate (41), two opposite side plates (42), a bottom plate (43) and two positioning hooks (45).

The cavity (400) is defined through the shell (40), accommodates the insulating housing (10), the first terminals (20) and the second terminals (30) and has a front opening serving as a socket hole. An axis of the socket hole is vertical to the PCB (90).

The side plates (42) are formed on the top plate (41) and each side plate (42) has a rear edge.

The bottom plate (43) is formed between the side plates (42) and are defined opposite to the top plate (41).

The positioning hooks (45) are formed on and protrude backward respectively from the rear edge of the side plates (42) and hook respectively in the positioning holes (92) of the PCB (90).

The first and second soldering sections (23, 33) of the first and second terminals (20, 30) of the vertical receptacle connector horizontally protrude out from the rear end (102) of the insulating housing (10) instead of bending perpendicularly down as configurations of the conventional receptacle connector. Accordingly, the vertical receptacle connector is mounted uprightly on the PCB (90) with its axis perpendicular to the PCB (90). Therefore, the vertical configuration of the vertical receptacle connector on the PCB (90) may be applied to specific electronic devices such as liquid crystal display (LCD) monitors to provide USB 3.0 data transmission.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A vertical receptacle connector comprising:
an insulating housing having a front end and a rear end;
multiple first terminals mounted on the insulating housing and each first terminal having a first soldering section extending horizontally backward out of the rear end of the insulating housing;
multiple second terminals mounted on the insulating housing, being capable of cooperating with the first terminals to implement USB 3.0 protocol and each second terminal having a second soldering section extending horizontally backward out of the rear end of the insulating housing; and
a shell covering the insulating housing, the first terminals and the second terminals and having a cavity defined through the shell and having a front opening serving as a socket hole.

2. The vertical receptacle connector as claimed in claim 1, wherein
the insulating housing further has
a base defined adjacent to the rear end and having a front and a rear; and
a tongue formed on and protruding horizontally forward from the front of the base, defined adjacent to the front end and having a bottom;
each first terminal further has a first mounting section and a first contacting section, the first mounting section is mounted in the base and the tongue, the first contacting section is formed on and protrudes forward from the first mounting section and is mounted on the bottom of the tongue, the first soldering section of the first terminal is formed on and protrudes horizontally backward from the first mounting section; and
each second terminals further has a second mounting section and a second contacting section, the second mounting section is mounted in the base, the second contacting section is formed on and protrudes forward from the second mounting section and is mounted in the bottom of the tongue, the second soldering section is formed on and protrudes horizontally backward from the second mounting section.

3. The vertical receptacle connector as claimed in claim 1, wherein the shell further has multiple positioning hooks protruding backward from the shell.

4. The vertical receptacle connector as claimed in claim 3, wherein
the shell further has:
a top plate;
two opposite side plates formed on the top plate and each side plate having a rear edge; and
a bottom plate formed between the two side plates and defined opposite to the top plate; and
two positioning hooks are formed on and protrude backward respectively from the rear edge of the two side plates.

5. The vertical receptacle connector as claimed in claim 1, wherein the first terminals are capable of implementing USB 2.0 protocol.

6. A vertical receptacle connector assembly comprising:
a PCB having multiple soldering holes defined through the PCB; and
a vertical receptacle connector having
an insulating housing having a front end and a rear end;
multiple first terminals mounted on the insulating housing, and each first terminal having a first soldering section extending horizontally backward out of the rear end of the insulating housing and mounted through one of the soldering holes of the PCB;
multiple second terminals mounted on the insulating housing, being capable of cooperating with the first terminals to implement USB 3.0 protocol and each second terminal having a second soldering section extending horizontally backward out of the rear end of the insulating housing and mounted through one of the soldering holes of the PCB; and
a shell covering the insulating housing, the first terminals and the second terminals and having a cavity defined through the shell and having a front opening serving as a socket hole.

7. The vertical receptacle connector assembly as claimed in claim 6, wherein
the insulating housing further has:
a base defined adjacent to the rear end and having a front and a rear; and
a tongue formed on and protruding horizontally forward from the front of the base, defined adjacent to the front end and having a bottom;
each first terminal further has a first mounting section and a first contacting section, the first mounting section is mounted in the base and the tongue, the first contacting section is formed on and protrudes forward from the first mounting section and is mounted on the bottom of the tongue, the first soldering section of the first terminal is formed on and protrudes horizontally backward from the first mounting section; and
each second terminals further has a second mounting section and a second contacting section, the second mounting section is mounted in the base, the second contacting section is formed on and protrudes forward from the second mounting section and is mounted in the bottom of the tongue, the second soldering section is formed on and protrudes horizontally backward from the second mounting section.

8. The vertical receptacle connector assembly as claimed in claim 6, wherein
the PCB has multiple positioning holes defined through the PCB; and
the shell further has multiple positioning hooks protruding backward from the shell and hooking respectively in the positioning holes.

9. The vertical receptacle connector assembly as claimed in claim 8, wherein
the PCB has two positioning holes;
the shell further has
a top plate;
two opposite side plates formed on the top plate and each side plate having a rear edge; and
a bottom plate formed between the two side plates and defined opposite to the top plate; and
two positioning hooks are formed on and protrude backward respectively from the rear edge of the side plates and hook respectively in the two positioning holes.

10. The vertical receptacle connector assembly as claimed in claim 6, wherein the first terminals are capable of implementing USB 2.0 protocol.
